(19) United States
(12) Patent Application Publication
(10) Pub. No.: US 2024/0046323 A1
(43) Pub. Date: Feb. 8, 2024

(54) SYSTEMS AND METHODS FOR MANAGING ENTITY RECOMMENDATIONS

(71) Applicant: Meta Platforms, Inc., Menlo Park, CA (US)

(72) Inventors: Erica Jean Virtue, Shelter Island Heights, NY (US); Liwen Lin, New York, NY (US)

(21) Appl. No.: 16/775,915

(22) Filed: Jan. 29, 2020

Related U.S. Application Data
(60) Provisional application No. 62/805,605, filed on Feb. 14, 2019.

(51) Int. Cl. G06Q 30/02; G06Q 50/00; G06F 16/9536

(52) U.S. Cl. CPC G06Q 30/0282; G06Q 50/01; G06F 16/9536

(57) ABSTRACT

Systems, methods, and non-transitory computer-readable media can provide an interface for accessing user recommendations for an entity, wherein the interface is provided in a page associated with the entity. Information describing the user recommendations for the entity can be provided in the interface. The information including at least a recommendation score for the entity, the recommendation score being determined based at least in part on the user recommendations for the entity, wherein the recommendation score indicates whether users recommend the entity.

### CROSS-REFERENCE TO RELATED APPLICATIONS

This application claims priority to U.S. Provisional Patent Application No. 62/805,605, filed on Feb. 14, 2019 and entitled “SYSTEMS AND METHODS FOR MANAGING ENTITY RECOMMENDATIONS”, which is incorporated in its entirety herein by reference.

### FIELD OF THE INVENTION

The present technology relates to the field of networked communications. More particularly, the present technology relates to techniques for providing entity recommendations in a computerized networking system.

### BACKGROUND

Today, people often utilize computing devices (or systems) for a wide variety of purposes. For example, users can use their computing devices to interact with other users, create content, share content, and view content. In some cases, users can utilize their computing devices to access a social network and post content to the social network. Content posted to the social network may include text content items and media content items, such as audio, images, and videos. The posted content may be published to the social network for consumption by others.

### SUMMARY

Various embodiments of the present technology can include systems, methods, and non-transitory computer readable media configured to provide an interface for accessing user recommendations for an entity, wherein the interface is provided in a page associated with the entity. Information describing the user recommendations for the entity can be provided in the interface. The information including at least a recommendation score for the entity, the recommendation score being determined based at least in part on the user recommendations for the entity, wherein the recommendation score indicates whether users recommend the entity.

In an embodiment, the user recommendations accessible from the interface include solicited recommendations that are requested when users access the page associated with the entity.

In an embodiment, a solicited recommendation includes a user response to a yes-no question asking whether the user recommends the entity.

In an embodiment, a solicited recommendation includes one or more selected tags describing the entity and text-based feedback.

In an embodiment, the user recommendations accessible from the interface include unsolicited recommendations for the entity that are provided as text-based feedback in posts published through the social networking system.

In an embodiment, the user recommendations accessible from the interface include user comments that provide recommendations for the entity in response to posts published through the social networking system.

In an embodiment, the user recommendations accessible from the interface include reviews for the entity provided under a legacy rating scheme in which users specify a numerical or star rating for the entity.

In an embodiment, the information describing the user recommendations for the entity provides a percentage of users that recommend the entity.

In an embodiment, the information describing the user recommendations for the entity provides a count of user recommendations from which the percentage is determined.

In an embodiment, the interface includes an option to respond to a solicited recommendation for the entity.

Various embodiments of the present technology can include systems, methods, and non-transitory computer readable media configured to obtain a set of user recommendations associated with an entity, wherein at least one of the user recommendations provides a user response to a yes-no question asking whether the user recommends the entity. Respective scores for the set of user recommendations can be determined. A recommendation score for the entity can be determined based at least in part on the respective scores for the set of user recommendations.

In an embodiment, at least one of the user recommendations provides a recommendation for the entity in a post published through a social networking system, wherein the post provides text-based feedback for the entity.

In an embodiment, at least one of the user recommendations provides a recommendation for the entity in a comment published in response to a post seeking recommendations through a social networking system, wherein the comment provides text-based feedback for the entity.

In an embodiment, at least one of the user recommendations provides a numerical rating for the entity based on a legacy rating scheme.

In an embodiment, determining respective scores for the set of user recommendations further includes determining a sentiment value for a user recommendation based at least in part on text-based feedback included in the user recommendation and determining a score for the user recommendation based at least in part on the sentiment value.

In an embodiment, the systems, methods, and non-transitory computer readable media are configured to determine respective weights for the set of user recommendations.

In an embodiment, determining respective weights for the set of user recommendations further includes determining a user recommendation provided as a post or comment published through a social networking system and applying a corresponding weight to the user recommendation based at least in part on a number of characters included in the post or comment.

In an embodiment, determining respective weights for the set of user recommendations further includes determining a user review of the entity based on a legacy rating scheme, the user review including a rating and text-based feedback and applying a corresponding weight to the user recommendation based at least in part on a number of characters included in the text-based feedback.

In an embodiment, determining the recommendation score for the entity further includes determining a respective weighted score for each user recommendation, wherein a weighted score for a user recommendation is based at least in part on a product of a respective weight and score for the user recommendation and determining the recommendation score for the entity based at least in part on the weighted scores for the user recommendations.

In an embodiment, one or more of the user recommendations are submitted through a page associated with the entity, the page being accessible from a social networking system.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example page module, according to an embodiment of the present technology.

FIG. 2A illustrates an example recommendation module, according to an embodiment of the present technology.

FIG. 2B illustrates an example solicited recommendation module, according to an embodiment of the present technology.

FIG. 2C illustrates an example recommendation score module, according to an embodiment of the present technology.

FIGS. 3A-3B illustrate example interfaces, according to an embodiment of the present technology.

FIGS. 4A-4C illustrates example interfaces, according to an embodiment of the present technology.

FIG. 5A illustrates an example method, according to an embodiment of the present technology.

FIG. 5B illustrates another example method, according to an embodiment of the present technology.

FIG. 6 illustrates a network diagram of an example system including an example social networking system that can be utilized in various scenarios, according to an embodiment of the present technology.

FIG. 7 illustrates an example of a computer system or computing device that can be utilized in various scenarios, according to an embodiment of the present technology.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Managing Entity Recommendations

Under conventional approaches, users can access various content through a content provider (e.g., a social networking system). Typically, a user operating a computing device can interact with the content provider over one or more computer networks. Further, the accessed content can be presented through a display screen by a software application (e.g., a web browser, social networking application, etc.) running on the computing device. Such conventional approaches permit users to conveniently access various types of content. For example, a page administrator may create and publish a page associated with an entity (e.g., a business, organization, point of interest, person, etc.) through the content provider. Users can access the page to view various information about the entity, such as location and hours of operation. In some instances, the page can include user reviews of the entity. These user reviews can include a numerical (or star) rating for the entity and text-based feedback. However, such user reviews may not provide an accurate representation of the entity. For example, a user review may include a rating and text-based feedback that are inconsistent with one another. As an example, a user may provide negative text-based feedback for the entity but may still provide a high rating due to some redeeming factor (e.g., desirable location, easy parking, etc.). In some instances, users may hesitate to provide a low rating and may opt to provide their negative opinion as text-based feedback instead. Such reviews can lead to confusion and may distort an overall rating associated with the entity. As a result, users may face difficulty in accurately discerning whether other users recommend the entity or not. Accordingly, such conventional approaches may not be effective in addressing these and other problems arising in computer technology.

An improved approach rooted in computer technology overcomes the foregoing and other disadvantages associated with conventional approaches specifically arising in the realm of computer technology. In various embodiments, users can provide recommendations for entities through a social networking system. In some embodiments, a user recommendation for an entity can be solicited. For example, a page associated with the entity can solicit recommendations from users that access the page. The solicited recommendation can request various types of feedback from the user. For example, in some embodiments, the solicited recommendation can ask the user whether they recommend the entity in the form of a yes-no question. Next, the user can be asked to select one or more tags that describe the entity (e.g., “great service”, “cozy atmosphere”, “no parking”, “free wi-fi”, etc.). The tags provided for selection can be used to provide positive or negative feedback depending on the user's response to the yes-no question. The user can also provide text-based feedback as part of the solicited recommendation. In various embodiments, user recommendations for the entity can be made accessible from the page associated with the entity. For example, the page associated with the entity can include a “recommendations” tab from which various types of user recommendations for the entity can be accessed. In some embodiments, such user recommendations can be used to generate a recommendation score for the entity. For example, the recommendation score can be determined based on user responses to solicited recommendations (e.g., yes-no response, selected tags, and text-based feedback). In some embodiments, each user recommendation can be weighted and mapped to a recommendation sub-score based on a sentiment determined for the user recommendation. The improved approach, therefore, allows users to provide meaningful feedback in response to solicited recommendations without having to provide a traditional numerical (or star) rating. More details relating to the present technology are provided below.

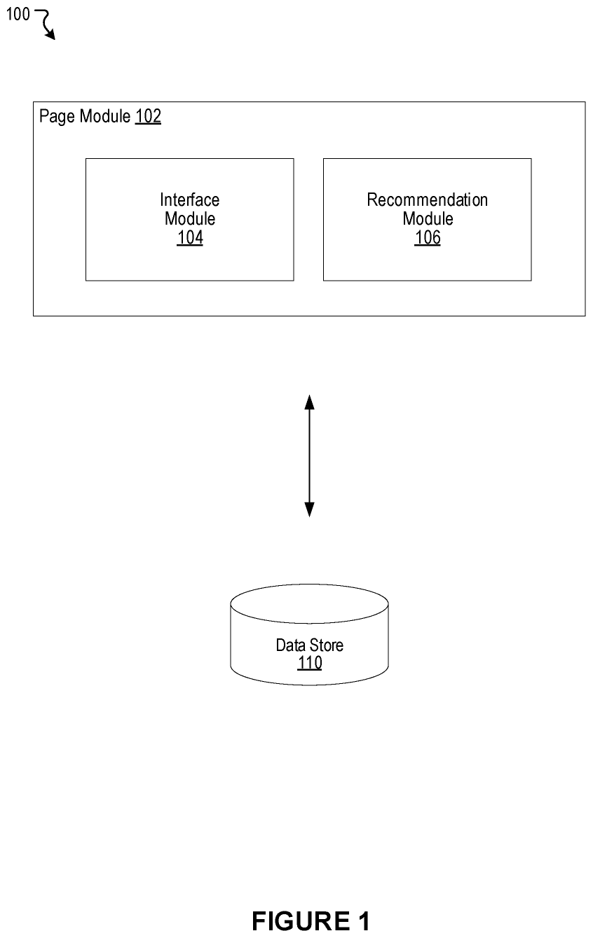

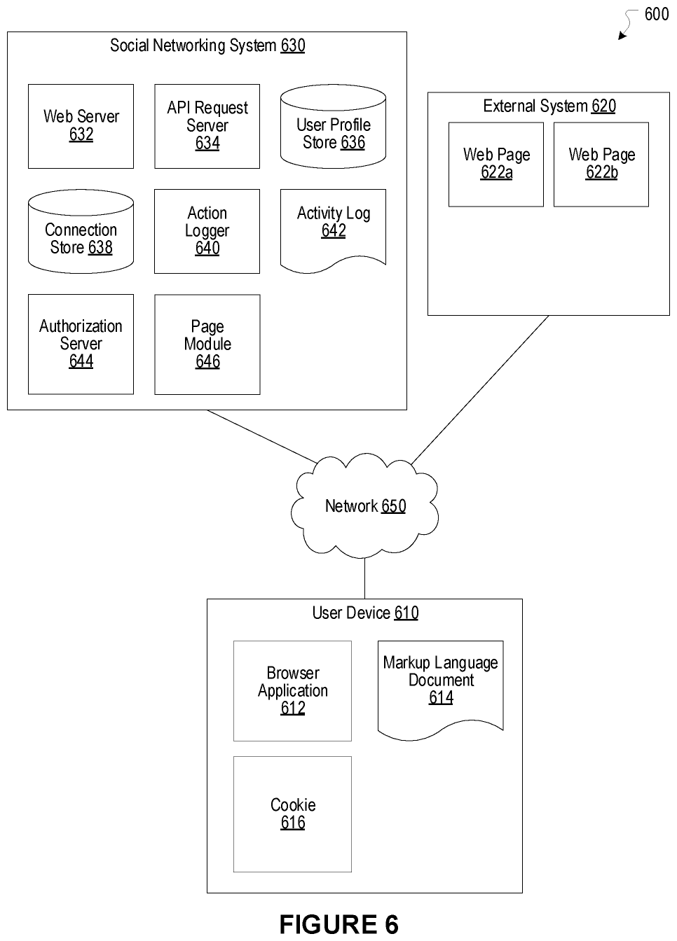

FIG. 1 illustrates an example system 100 including an example page module 102, according to an embodiment of the present technology. In some embodiments, the page module 102 can be configured to manage user recommendations for entities. The user recommendations can be accessed through a content provider (e.g., a social networking system such as a social networking system 630 of FIG. 6). As shown in the example of FIG. 1, the page module 102 can include an interface module 104 and a recommendation module 106. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details.

In some embodiments, the page module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the page module 102 or at least a portion thereof can be implemented using one or more computing devices or systems that include one or more servers, such as network servers or cloud servers. In some instances, the page module 102 can, in part or in whole, be implemented within or configured to operate in conjunction with a social networking system (or service), such as the social networking system 630 of FIG. 6. In some instances, the page module 102 can be, in part or in whole, implemented within or configured to operate in conjunction or be integrated with a client computing device, such as the user device 610 of FIG. 6. For example, the page module 102 can be implemented as or within a dedicated application (e.g., app), a program, or an applet running on a user computing device or client computing system. The application incorporating or implementing instructions for performing some, or all, functionality of the page module 102 can be created by a developer. The application can be provided to or maintained in a repository. In some cases, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

The page module 102 can be configured to communicate and/or operate with the at least one data store 110, as shown in the example system 100. The at least one data store 110 can be configured to store and maintain various types of data used by the page module 102. In some embodiments, the data store 110 can store information describing users, pages, and various content (e.g., video content) associated with pages. In some implementations, the at least one data store 110 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 110 can store information associated with users, such as user identifiers, user information, profile information, user specified settings, content produced or posted by users, and various other types of user data.

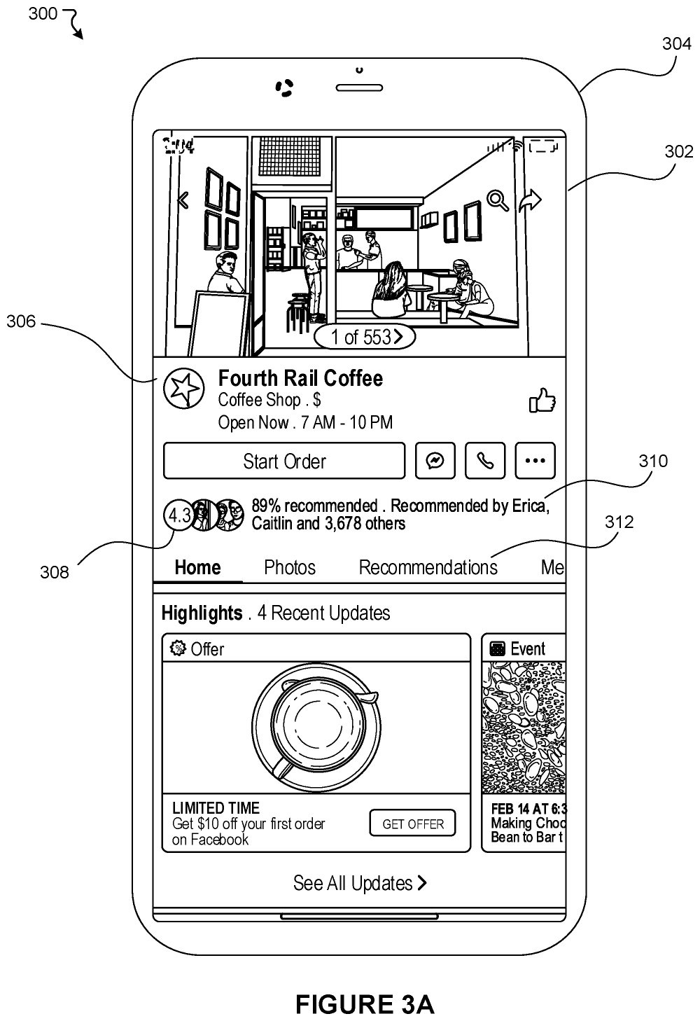

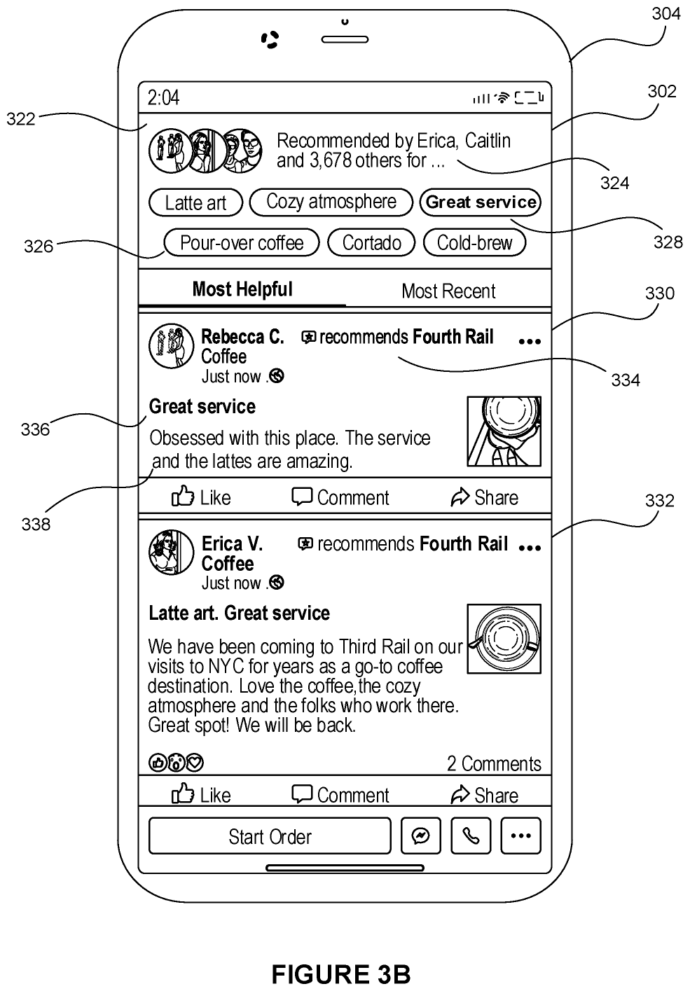

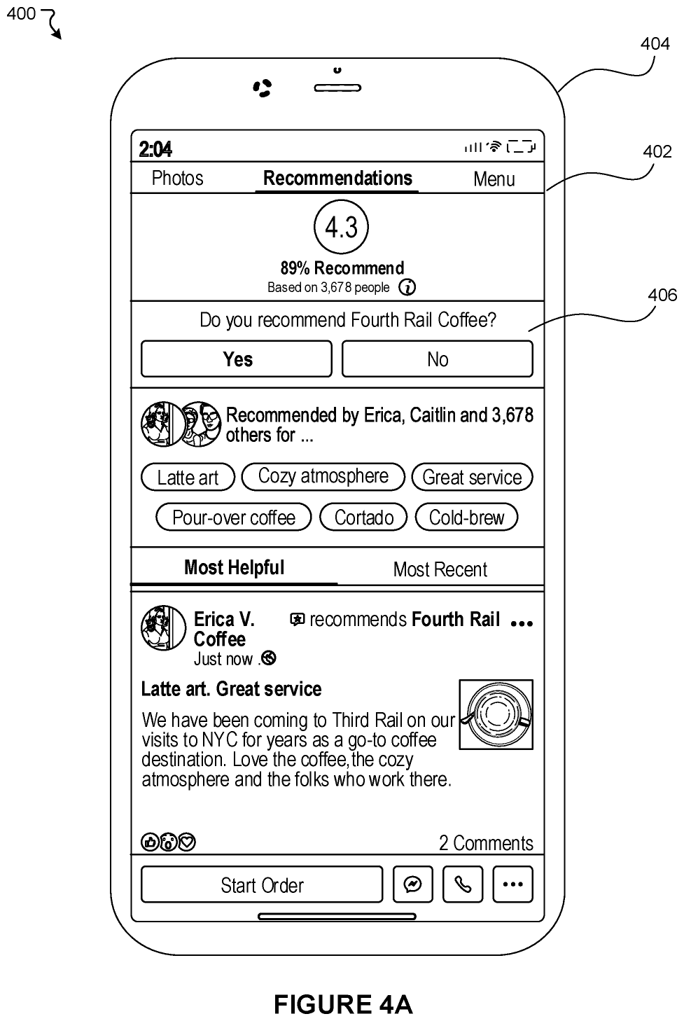

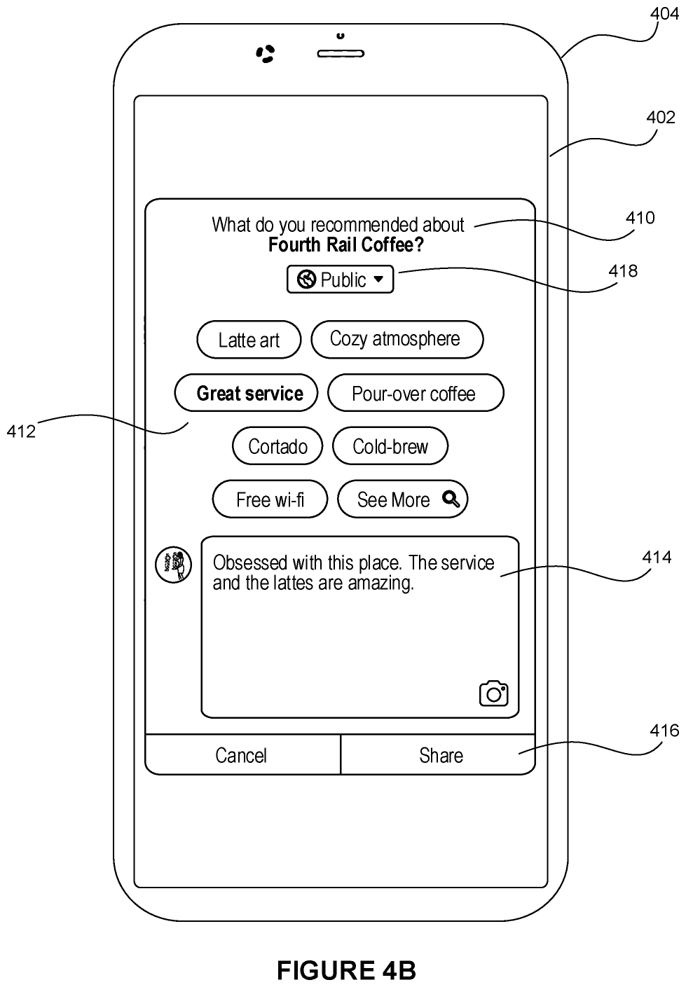

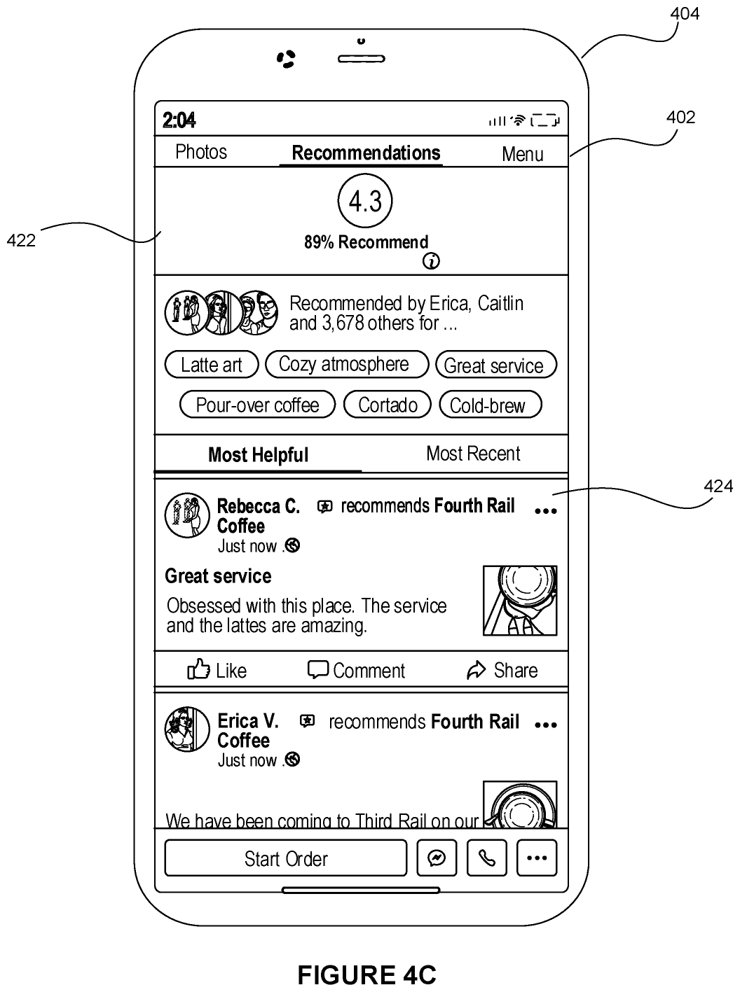

The interface module 104 can be configured to provide one or more interfaces (e.g., graphical user interfaces). The interfaces may be presented through a display screen of a computing device. A user operating the computing device can interact with an interface using various touchscreen gestures or an external apparatus, for example. In various embodiments, the interface module 104 can provide one or more interfaces supporting the recommendation module 106. These interfaces can be used to manage and access user recommendations for entities. More details regarding the interfaces will be provided below with reference to FIGS. 3A-3B and 4A-4C.

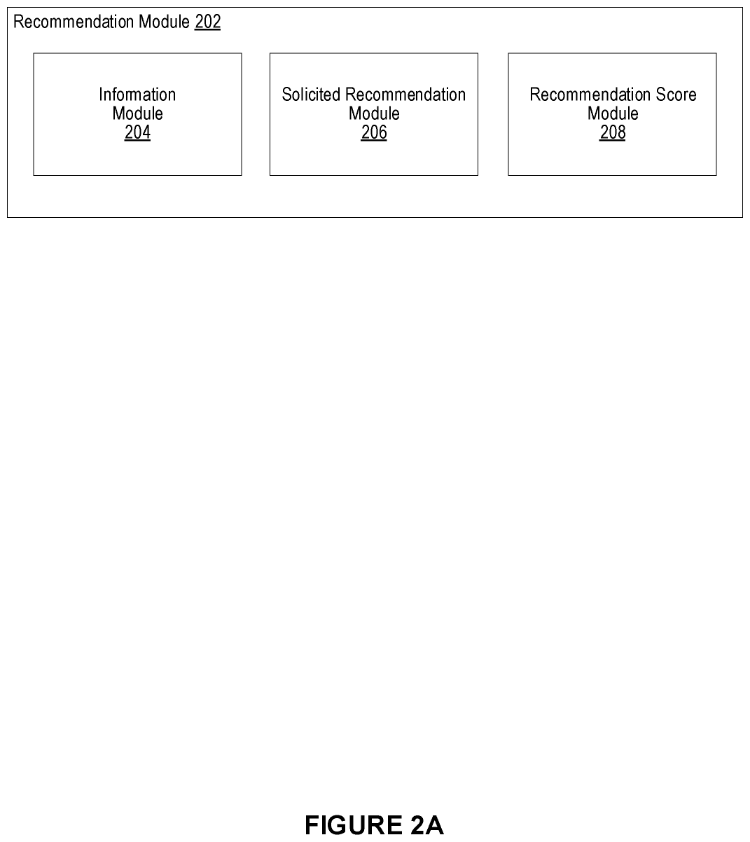

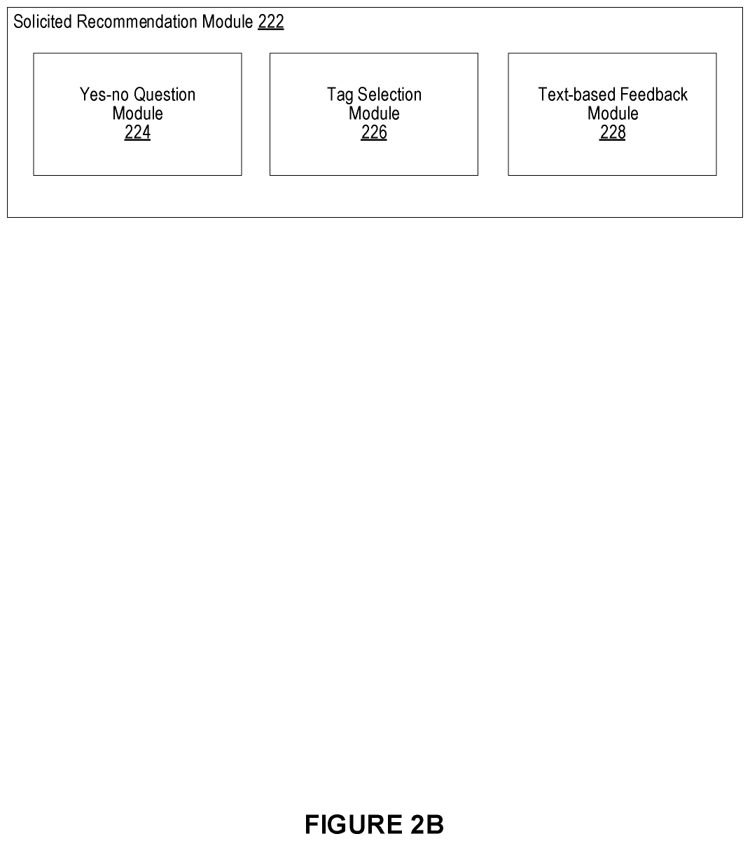

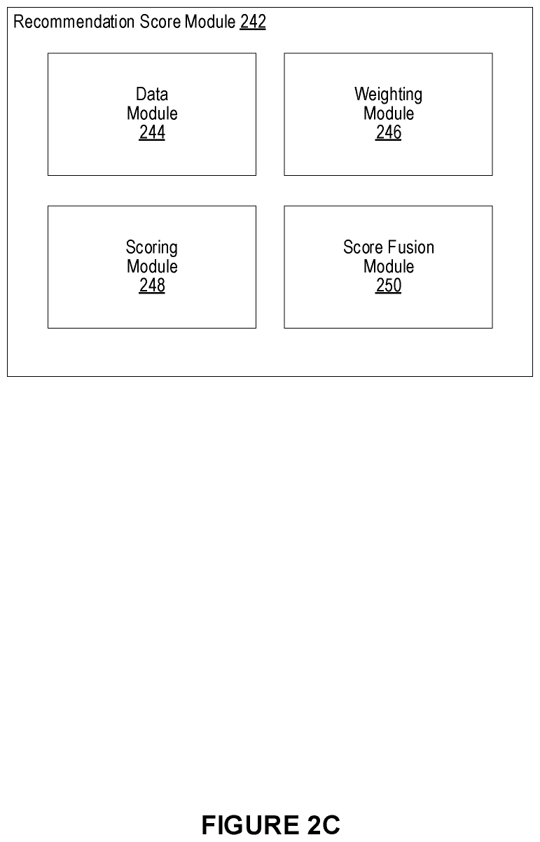

The recommendation module 106 can be configured to manage user recommendations for entities. For example, in some embodiments, user recommendations for an entity can be accessed from a page associated with the entity. The entity may be a business, such as a restaurant or coffee shop; an organization; or a point of interest, to name some examples. A page administrator can create a page representing the entity through the social networking system. Users of the social networking system can access various information about the entity through the page including, for example, location, business hours, menu, and content (e.g., shared images, videos, etc.). In some embodiments, the page can include information describing user recommendations for the entity. More details regarding the recommendation module 106 will be provided below with reference to FIG. 2A.

FIG. 2A illustrates a recommendation module 202, according to an embodiment of the present technology. In some embodiments, the recommendation module 106 of FIG. 1 can be implemented with the recommendation module 202. As shown in the example of FIG. 2A, the recommendation module 202 can include an information module 204, a solicited recommendation module 206, and a recommendation score module 208.

The information module 204 can maintain various information describing user recommendations for entities. In various embodiments, such information can be accessed through the social networking system from pages associated with the entities. For example, in some embodiments, the information module 204 can maintain various types of user recommendations that were submitted for an entity. For example, in some embodiments, recommendations for entities can be solicited, as described below in reference to the solicited recommendation module 206. In some instances, the social networking system may have access to other types of user recommendations for an entity. For example, an entity may be associated with unsolicited recommendations (e.g., posts) published through the social networking system in which users recommend the entity. In another example, the social networking system can access user comments that provide recommendations for the entity in response to posts seeking recommendations. That is, a first user may post a request for recommendations and a second user can provide a recommendation as a comment to the post. In yet another example, an entity may be associated with user reviews provided under a legacy rating scheme that asks users to assign a numerical (or star) rating to the entity. In various embodiments, the information module 204 can manage the various types of recommendations. In some embodiments, the various types of recommendations for an entity can be accessible to users through a page associated with the entity. For example, the page can include a “recommendations” tab under which the various types of entity recommendations are accessible. In some embodiments, the information module 204 can maintain a recommendation score for the entity. The recommendation score can reflect an overall recommendation for the entity based on the user recommendations for the entity. In some embodiments, recommendation scores may correspond to a pre-defined numerical range (e.g., 1 to 5, 1 to 10, etc.). In various embodiments, information maintained by the information module 204 can be made accessible through pages published through the social networking system, as described below with reference to FIGS. 3A-3B.

The solicited recommendation module 206 can solicit recommendations from users. In various embodiments, the solicited recommendation module 206 can solicit recommendations for an entity within a page associated with the entity. For example, a user that visits the page can be provided a feedback interface that solicits various feedback about the entity. More details regarding the solicited recommendation module 206 will be provided below with reference to FIG. 2B.

The recommendation score module 208 can generate recommendation scores for entities. In various embodiments, a recommendation score for an entity can be determined based on user recommendations submitted for the entity. More details regarding the recommendation score module 208 will be provided below with reference to FIG. 2C.

FIG. 2B illustrates a solicited recommendation module 222, according to an embodiment of the present technology. In various embodiments, the solicited recommendation module 222 can provide a feedback interface that solicits user recommendations for entities. For example, a feedback interface can be provided within a page associated with an entity. The feedback interface can ask users to provide various types of feedback as part of a feedback flow. For example, the feedback flow can include a first component that asks the user whether they recommend the entity in the form of a yes-no question. The feedback flow can also include a second component that asks the user to select one or more tags that describe the entity (e.g., “poor service”, “dim lighting”, “free parking”, etc.). Further, the feedback flow can include a third component that allows the user to provide text-based feedback as part of their recommendation. Once submitted, the user recommendation can be published in the page and made accessible to other users. In some embodiments, the solicited recommendation module 206 of FIG. 2A can be implemented with the solicited recommendation module 222. As shown in the example of FIG. 2B, the solicited recommendation module 222 can include a yes-no question module 224, a tag selection module 226, and a text-based feedback module 228.

The yes-no question module 224 can prompt users to provide a recommendation for an entity in the form of a yes-no question. For example, a user may be prompted for a recommendation when the user visits a page associated with an entity. In another example, a user may be prompted for a recommendation when the user selects a check-in option associated with the entity. A user can select a “yes” or “no” option in response to the yes-no question. As a result, users are able to provide a binary recommendation for the entity without having to arbitrarily rate the entity based on some numerical or star-based legacy rating system.

The tag selection module 226 can prompt users to select one or more tags that describe the entity. In various embodiments, a tag can include descriptive words or phrases that describe some aspect of an entity. In general, tags may be positive, negative, or neutral in their recommendation of an entity. Some examples of positive tags include “great service”, “cozy atmosphere”, “free parking”, “great food”, and “free wi-fi”. Some examples of negative tags include “poor service”, “dim lighting”, “no parking”, “bad food”, and “no wi-fi”. Some examples of neutral tags include “coffee”, “fast food”, “latte”, and “local spot”. In some embodiments, user responses to the yes-no question can affect which tags are provided for selection. For example, a user that responded to the yes-no question with a “yes” recommendation can be shown positive tags. In contrast, a user that responded to the yes-no question with a “no” recommendation can be shown negative tags. In general, tags provided for selection may be pre-defined by the social networking system. In some embodiments, entities can specify customized tags that users can select when providing a recommendation for entity. In some embodiments, candidate tags for an entity can be generated automatically from text-based feedback provided by users. For example, user posts that reference the entity can be evaluated to identify common terms or phrases used to describe the entity. These common terms or phrases can then be used as candidate tags for the entity.

The text-based feedback module 228 can prompt users to provide text-based feedback for the entity. For example, users can be provided with a free-form text field in which they can provide feedback. In some instances, the text-based feedback allows users to provide context for their yes-no recommendations for entities.

FIG. 2C illustrates a recommendation score module 242, according to an embodiment of the present technology. In various embodiments, the recommendation score module 242 can generate recommendation scores for entities based on user recommendations for the entities. In some embodiments, the recommendation score module 208 of FIG. 2A can be implemented with the recommendation score module 242. As shown in the example of FIG. 2C, the recommendation score module 242 can include a data module 244, a weighting module 246, a scoring module 248, and a score fusion module 250.

The data module 244 can obtain various types of user recommendations associated with an entity. These various types of user recommendations can be used to compute a recommendation score for the entity. In some embodiments, user recommendations can include solicited recommendations. For example, in some embodiments, recommendations for entities can be solicited when users access pages associated with the entities. The data module 244 can also access other types of entity recommendations. In some embodiments, the data module 244 can access unsolicited recommendations for entities. For example, an unsolicited recommendation can be a post in which a user provides text-based feedback for an entity. In some embodiments, the data module 244 can access structured comments that include recommendations. For example, users may comment in response to posts seeking recommendations. These comments can include recommendations for entities in the form of text-based feedback. In some embodiments, the data module 244 can access ratings and reviews associated with entities. Such ratings and reviews may have been submitted by users under a legacy rating scheme that asks users to provide numerical (or star) ratings for entities in addition to text-based feedback.

The weighting module 246 can apply respective weights to the user recommendations obtained for the entity by the data module 244. In various embodiments, the weights applied can vary depending on the type of user recommendation being weighted. For example, in some embodiments, an unsolicited recommendation (e.g., a post including text-based feedback) can be weighted based on a number of characters included in text-based feedback associated with the unsolicited recommendation. For example, if the number of characters is less than a pre-defined value (e.g., less than 20), then a first weight value (e.g., 0.2) can be applied to the unsolicited recommendation. If the number of characters is between a pre-defined range (e.g., between 20 and 50), then a second weight value (e.g., 0.5) can be applied to the unsolicited recommendation. Finally, if the number of characters is greater than a pre-defined value (e.g., greater than 50), then a third weight value (e.g., 1.0) can be applied to the unsolicited recommendation. In some embodiments, a structured comment can also be weighted based on a number of characters included in the comment. For example, if the number of characters is less than a pre-defined value (e.g., 20), then a first weight value (e.g., 0.5) can be applied to the structured comment. If the number of characters is between a pre-defined range (e.g., between 19 and 50), then a second weight value (e.g., 0.75) can be applied to the structured comment. Finally, if the number of characters is greater than a pre-defined value (e.g., greater than 50), then a third weight value (e.g., 1.0) can be applied to the structured comment. In some embodiments, ratings (e.g., numerical or star ratings) provided for the entity under a legacy rating scheme can also be weighted. For example, ratings can be weighted based on a ratio of all ratings for the entity (e.g., all numerical or star ratings) to all ratings and reviews (e.g., text-based feedback) provided for the entity. In some embodiments, ratings can be weighted as follows:

$$\frac{ratings}{ratings + reviews}$$

where ratings corresponds to the total number of ratings for the entity, and where reviews corresponds to the total number of reviews for the entity. Many variations are possible. For example, in some embodiments, if an entity is associated with less than a pre-defined number of ratings and reviews (e.g., 30 ratings and reviews), the ratings can be weighted as follows:

$$\sqrt{\frac{ratings}{ratings + reviews}}$$

where ratings corresponds to the total number of ratings for the entity, and where reviews corresponds to the total number of reviews for the entity. In some embodiments, reviews (e.g., text-based feedback) provided for the entity under a legacy rating scheme can be used to determine weights for ratings. For example, a review of an entity can include text-based feedback. The review can also be associated with a rating (e.g., a numerical or star rating). In some embodiments, if the total number of reviews associated with the entity exceeds a pre-defined value (e.g., 1,000), then a pre-defined weight value (e.g., 0) can be applied to all ratings associated with the reviews. In some embodiments, a pre-defined weight value (e.g., 1.0) is applied to all solicited recommendations associated with the entity. Many variations are possible.

The scoring module 248 can generate respective scores for the user recommendations obtained for the entity by the data module 244. In some embodiments, entities associated with fewer than a pre-defined number of user recommendations (e.g., 30 total user recommendations) can be scored by discounting any ratings associated with the entity to a baseline rating which gradually improves as the number of user recommendations increases. For example, such entities can be scored as follows:

s=c*t+d

where s is the score, where c is a constant value (e.g., 0.016), where t is the total number of user recommendations for the entity, and where d is a baseline rating (e.g., 4.5 when rating values range from 1 to 5). In various embodiments, the scoring can vary depending on the type of user recommendation being scored. For example, in some embodiments, a score can be determined for an unsolicited recommendation (e.g., a post including text-based feedback) based on a sentiment value determined for the unsolicited recommendation. The sentiment value can be determined based on a generally known sentiment classifier. For example, the sentiment classifier can evaluate text-based feedback in an unsolicited recommendation to determine a sentiment value. The sentiment value can range from −1 to 1 where a value of −1 indicates very negative sentiment and a value of 1 indicates very positive sentiment. In some embodiments, the unsolicited recommendation is assigned a score of 1 if its sentiment value is between a first pre-defined range (e.g., between −1 and −0.6). In some embodiments, the unsolicited recommendation is assigned a score of 2 if its sentiment value is between a second pre-defined range (e.g., between −0.6 and 0). In some embodiments, the unsolicited recommendation is assigned a score of 3 if its sentiment value is between a third pre-defined range (e.g., between 0 and 0.5). In some embodiments, the unsolicited recommendation is assigned a score of 4 if its sentiment value is between a fourth pre-defined range (e.g., between 0.5 and 0.8). In some embodiments, the unsolicited recommendation is assigned a score of 5 if its sentiment value is between a fifth pre-defined range (e.g., between 0.8 and 1). In some embodiments, a score can be determined for a structured comment based on a sentiment value determined for the comment. In some embodiments, the structured comment is assigned a score of 2 if its sentiment value is between a first pre-defined range (e.g., between −1 and −0.5). In some embodiments, the structured comment is assigned a score of 3 if its sentiment value is between a second pre-defined range (e.g., between −0.5 and 0). In some embodiments, the structured comment is assigned a score of 4 if its sentiment value is between a third pre-defined range (e.g., between 0 and 0.7). In some embodiments, the structured comment is assigned a score of 5 if its sentiment value is between a fourth pre-defined range (e.g., between 0.7 and 1). In some embodiments, a score can be determined for a solicited recommendation based on a sentiment value associated with the solicited recommendation. For example, the sentiment value can be determined based on text-based feedback included in the solicited recommendation. In some embodiments, a solicited recommendation associated with a positive sentiment can be assigned a score of 4 or 5. For example, the solicited recommendation can be assigned a score of 4 if its sentiment value is between a first pre-defined range (e.g., 0.5 and 0.8) or a score of 5 if its sentiment value is between a second pre-defined range (e.g., between 0.8 and 1). In some embodiments, a solicited recommendation associated with a neutral sentiment can be assigned a score of 2 or 3. For example, the solicited recommendation can be assigned a score of 2 if its sentiment value is between a first pre-defined range (e.g., −0.8 and −0.5) or a score of 3 if its sentiment value is between a second pre-defined range (e.g., between −0.5 and 0.5). In some embodiments, a solicited recommendation associated with a negative sentiment can be assigned a score of 1. For example, the solicited recommendation can be assigned a score of 1 if its sentiment value is less than a pre-defined value (e.g., less than −0.8). Many variations are possible.

The score fusion module 250 can determine the recommendation score for the entity. In some embodiments, the recommendation score can be based on the weights determined by the weighting module 246 and the scores determined by the scoring module 248 for all user recommendations associated with the entity. For example, in some embodiments, the recommendation score for the entity can be determined as follows:

$$\frac{\sum ( {weight}_{n} * {score}_{n} )}{\sum ( {weight}_{n} )}$$

where weight corresponds to a weight determined for a user recommendation for the entity and where score corresponds a score determined for the user recommendation. In some embodiments, ratings and reviews provided under a legacy rating scheme can be decayed. For example, in some embodiments, a decaying function can be applied to all ratings and reviews associated with a best numerical (or star) rating. For example, the decaying function can be applied to all ratings and reviews associated with a numerical (or star) rating of 5 with 5 being the best rating. In some embodiments, the decaying function can have a pre-defined half-life (e.g., 500, 520, 540, etc.) and corresponding decay weight (e.g., 0.5, 0.8, etc.). For example, assuming a half-life of 540 days, if a rating was created a year and a half ago, its decay weight can be 0.5. In some embodiments, the recommendation score for the entity can be determined based on a decaying function as follows:

$$\frac{\sum ( {weight}_{n} * {score}_{n} * decay )}{\sum ( {weight}_{n} * decay )}$$

where weight corresponds to a weight determined for a user recommendation for the entity, where score corresponds a score determined for the user recommendation, and where decay corresponds to a decaying weight for the user recommendation. In some embodiments, to prevent decaying of user recommendations that were not provided under the legacy rating scheme, a decay weight of 1 can be applied to such user recommendations. Many variations are possible.

FIG. 3A illustrates an example 300 of an interface 302 that can be implemented by the page module 102, according to an embodiment of the present disclosure. In this example, the interface 302 is presented through a display screen of the computing device 304. Further, the interface 302 may be provided through an application (e.g., a web browser, a social networking application, messenger application, etc.) running on the computing device 304 that is configured to interact with the social networking system. In the example of FIG. 3A, a page 306 associated with an entity (“Fourth Rail Coffee”) is being accessed through the interface 302. The page 306 can include various information describing the entity including, for example, a recommendation score 308 for the entity. In some embodiments, information 310 describing users that recommended the entity can be provided. For example, the information 310 can identify users that recommended the entity. The information 310 can also provide a count of users that recommended the entity. The page 306 can also include a recommendations tab 312 that can be selected to access various types of user recommendations associated with the entity including, for example, solicited recommendations, unsolicited recommendations, structured comments, and ratings and reviews from a legacy rating scheme, as illustrated in the example of FIG. 3B. For example, FIG. 3B illustrates an interface 322 that provides recommendation information 324. For example, the recommendation information 324 can identify users that recommended the entity. In some embodiments, the recommendation information 324 can include a count of users that recommended the entity. In some embodiments, the recommendation information 324 can show tags 326 associated with the entity. For example, users may select tags to be associated with the entity when providing responses to solicited recommendations. In some embodiments, a set of tags that are most selected for the entity are shown in the interface 322. In some embodiments, one or more tags can be selected to filter user recommendations that can be accessed from the interface 322. For example, in the example of FIG. 3B, the user recommendations 330, 332 are shown because they are associated with a selected tag 328 (“Great service”). In some embodiments, the user recommendations 330, 332 are presented as part of a content feed that can be scrolled to access additional user recommendations for the entity. In some embodiments, a user recommendation can provide information 334 identifying a user and indicating whether the user recommends or does not recommend the entity. In some embodiments, a user recommendation can identify tags 336 associated with the user recommendation. In some embodiments, a user recommendation can include text-based feedback 338 associated with the user recommendation. Many variations are possible.

FIG. 4A illustrates an example 400 of an interface 402 that can be implemented by the page module 102, according to an embodiment of the present disclosure. In this example, the interface 402 is presented through a display screen of the computing device 404. Further, the interface 402 may be provided through an application (e.g., a web browser, a social networking application, messenger application, etc.) running on the computing device 404 that is configured to interact with the social networking system. In the example of FIG. 4A, the interface 402 provides options 406 for providing a response to a solicited recommendation. For example, the interface 402 can prompt users with a yes-no question that asks whether the users recommend the entity (e.g., “Fourth Rail Coffee”). A user operating the computing device 404 can respond by selecting either a yes or no option. After selecting the yes or no option, the user can be provided an interface 410 for submitting feedback, as illustrated in the example of FIG. 4B. For example, the interface 410 can provide tags 412 that can be selected for association with the entity. The interface 410 can also provide a field 414 for inputting text-based feedback. A share option 416 can be selected to share the solicited recommendation. In some embodiments, an option 418 can be selected to share the solicited recommendation publicly or privately. In some embodiments, the solicited recommendation 424 can be shared in a page 422 associated with the entity, as illustrated in the example of FIG. 4C.

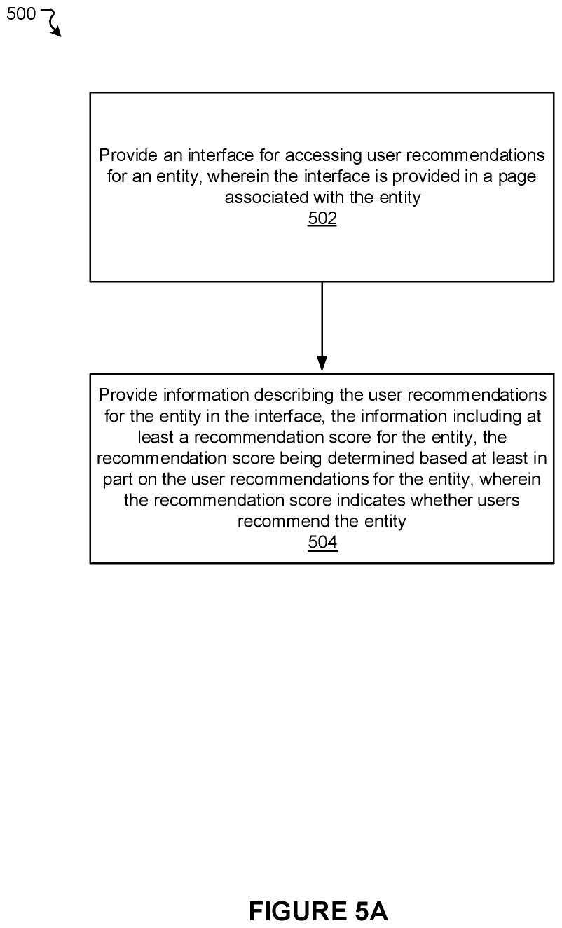

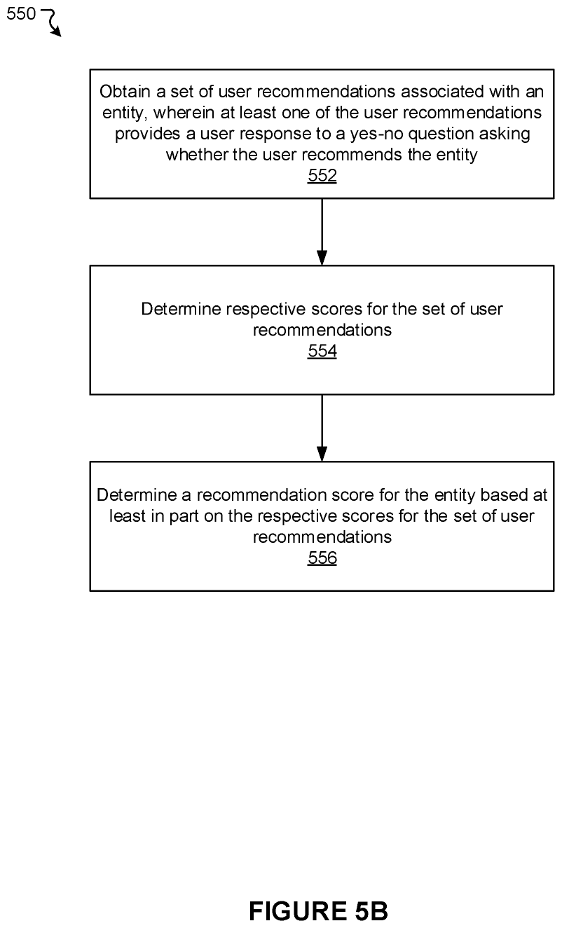

FIG. 5A illustrates an example method 500, according to an embodiment of the present technology. It should be appreciated that there can be additional, fewer, or alternative steps performed in similar or alternative orders, or in parallel, within the scope of the various embodiments discussed herein unless otherwise stated.

At block 502, an interface for accessing user recommendations for an entity can be provided. The interface can be provided in a page associated with the entity. At block 504, information describing the user recommendations for the entity can be provided in the interface. The information including at least a recommendation score for the entity, the recommendation score being determined based at least in part on the user recommendations for the entity, wherein the recommendation score indicates whether users recommend the entity.

FIG. 5B illustrates an example method 550, according to an embodiment of the present technology. It should be appreciated that there can be additional, fewer, or alternative steps performed in similar or alternative orders, or in parallel, within the scope of the various embodiments discussed herein unless otherwise stated.

At block 552, a set of user recommendations associated with an entity can be obtained. At least one of the user recommendations provides a user response to a yes-no question asking whether the user recommends the entity. At block 554, respective scores for the set of user recommendations can be determined. At block 556, a recommendation score for the entity can be determined based at least in part on the respective scores for the set of user recommendations.

It is contemplated that there can be many other uses, applications, and/or variations associated with the various embodiments of the present technology. For example, in some cases, user can choose whether or not to opt-in to utilize the disclosed technology. The disclosed technology can also ensure that various privacy settings and preferences are maintained and can prevent private information from being divulged. In another example, various embodiments of the present technology can learn, improve, and/or be refined over time.

### Social Networking System—Example Implementation

FIG. 6 illustrates a network diagram of an example system 600 that can be utilized in various scenarios, in accordance with an embodiment of the present technology. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices (or systems) that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the Silverlight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content. As discussed previously, it should be appreciated that there can be many variations or other possibilities.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622 a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a page module 646. The page module 646, for example, can be implemented as some or all of the functionality of the page module 102 of FIG. 1. As discussed previously, it should be appreciated that there can be many variations or other possibilities.

### Hardware Implementation

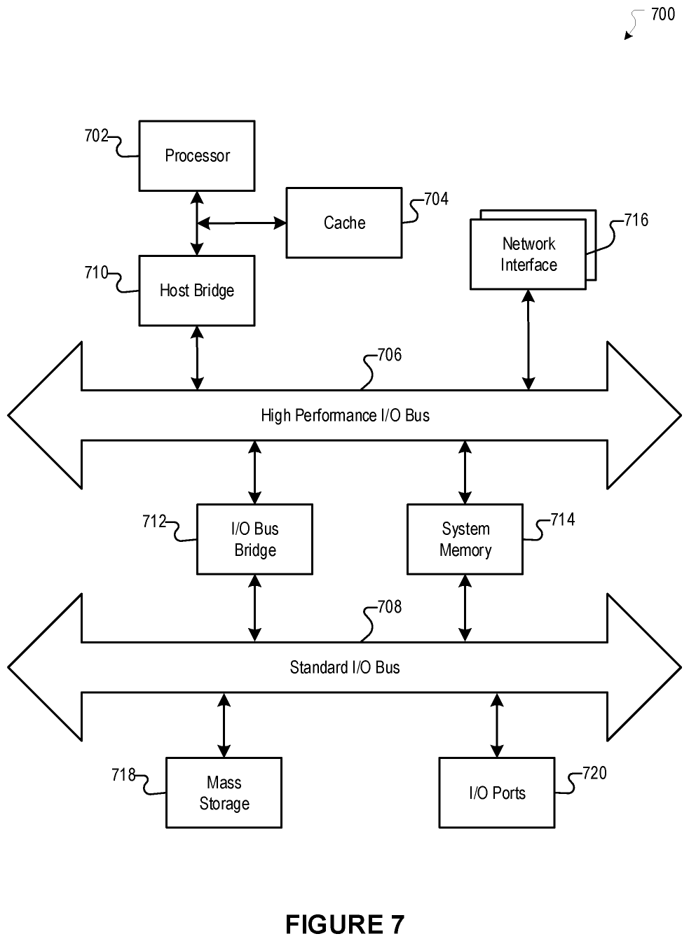

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, California, and the x86-compatible processors manufactured by Advanced Micro Devices (AMD), Inc., of Sunnyvale, California, as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, California, UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method comprising:
providing, by a computing system, an interface for accessing user recommendations for an entity, wherein the interface is provided in a page associated with the entity;
providing, by the computing system, information describing the user recommendations for the entity in the interface, the information including at least a recommendation score for the entity, the information further including selectable tags describing the entity that are presented through the interface, the selectable tags determined based on a user response to a question; and
in response to selection of a tag presented through the interface, filtering, by the computing system, user recommendations about the entity that are not associated with the tag out of the interface so that user recommendations about the entity that are associated with the tag are presented through the interface.

2. The computer-implemented method of claim 1, wherein the user recommendations accessible from the interface include solicited recommendations that are requested when users access the page associated with the entity.

3. The computer-implemented method of claim 2, wherein a solicited recommendation includes the user response to a yes-no question asking whether the user recommends the entity.

4. The computer-implemented method of claim 2, wherein a solicited recommendation includes one or more selected tags describing the entity and text-based feedback.

5. The computer-implemented method of claim 1, wherein the user recommendations accessible from the interface include unsolicited recommendations for the entity that are provided as text-based feedback in posts published through the social networking system.

6. The computer-implemented method of claim 1, wherein the user recommendations accessible from the interface include user comments that provide recommendations for the entity in response to posts published through the social networking system.

7. The computer-implemented method of claim 1, wherein the user recommendations accessible from the interface include reviews for the entity provided under a legacy rating scheme in which users specify a numerical or star rating for the entity.

8. The computer-implemented method of claim 1, wherein the information describing the user recommendations for the entity provides a percentage of users that recommend the entity.

9. The computer-implemented method of claim 8, wherein the information describing the user recommendations for the entity provides a count of user recommendations from which the percentage is determined.

10. The computer-implemented method of claim 1, wherein the interface includes an option to respond to a solicited recommendation for the entity.

11. A system comprising:
at least one processor; and
a memory storing instructions that, when executed by the at least one processor, cause the system to perform:
providing an interface for accessing user recommendations for an entity, wherein the interface is provided in a page associated with the entity;
providing information describing the user recommendations for the entity in the interface, the information including at least a recommendation score for the entity, the information further including selectable tags describing the entity that are presented through the interface, the selectable tags determined based on a user response to a question;
and
in response to selection of a tag presented through the interface, filtering user recommendations about the entity that are not associated with the tag out of the interface so that user recommendations about the entity that are associated with the tag are presented through the interface.

12. The system of claim 11, wherein the user recommendations accessible from the interface include solicited recommendations that are requested when users access the page associated with the entity.

13. The system of claim 12, wherein a solicited recommendation includes the user response to a yes-no question asking whether the user recommends the entity.

14. The system of claim 12, wherein a solicited recommendation includes one or more selected tags describing the entity and text-based feedback.

15. The system of claim 11, wherein the user recommendations accessible from the interface include unsolicited recommendations for the entity that are provided as text-based feedback in posts published through the social networking system.

16. A non-transitory computer-readable storage medium including instructions that, when executed by at least one processor of a computing system, cause the computing system to perform a method comprising:
providing an interface for accessing user recommendations for an entity, wherein the interface is provided in a page associated with the entity;
providing information describing the user recommendations for the entity in the interface, the information including at least a recommendation score for the entity, the information further including selectable tags describing the entity that are presented through the interface, the selectable tags determined based on a user response to a question;
and
in response to selection of a tag presented through the interface, filtering user recommendations about the entity that are not associated with the tag out of the interface so that user recommendations about the entity that are associated with the tag are presented through the interface.

17. The non-transitory computer-readable storage medium of claim 16, wherein the user recommendations accessible from the interface include solicited recommendations that are requested when users access the page associated with the entity.

18. The non-transitory computer-readable storage medium of claim 17, wherein a solicited recommendation includes the user response to a yes-no question asking whether the user recommends the entity.

19. The method of claim 1, wherein the selectable tags are determined based on a user response to a question asking whether the user recommends the entity.

20. (canceled)

21. The method of claim 1, wherein the user recommendations about the entity that are associated with the tag are not based on numerical ratings or star ratings.
